(19) United States
(12) Patent Application Publication
(10) Pub. No.: US 2010/0073439 A1
(43) Pub. Date: Mar. 25, 2010

(54) SHUTTLE MOUNTED PRESSURE CONTROL DEVICE FOR INKJET PRINTER

(75) Inventors: Paul Wouters, O.L.V. Waver (BE); Werner Van De Wynckel, Wolvertem (BE)

Correspondence Address: AGFA;c/o KEATING & BENNETT, LLP, 1800 Alexander Bell Drive, SUITE 200, Reston, VA, 20191, US

(73) Assignee: AGFA GRAPHICS NV, Mortsel (BE)

(21) Appl. No.: 12/517,236

(22) PCT Filed: Dec. 6, 2007
(86) PCT No.: PCT/EP07/63379

§ 371 Date: Jun. 2, 2009

Related U.S. Application Data
(60) Provisional application No. 60/875,471, filed on Dec. 18, 2006.

(30) Foreign Application Priority Data
Dec. 11, 2006 (EP) 06125761.4

(51) Int. Cl. B41J 2/175

(52) U.S. Cl. 347/85

(57) ABSTRACT

A shuttle air supply system which regulates the air pressure in an ink tank of an inkjet printer includes a vacuum supply line coupled to a fixed vacuum source, a valve for controlling the opening of the vacuum supply line actuated by a valve control circuit obtaining measurements from a pressure sensor sensing the pressure in the ink tank and wherein the pressure in the ink tank is regulated by the valve control circuit to a desired ink tank pressure. A pressurized air supply line coupled to a fixed value pressurized air supply and an air pressure valve controlled by the valve control circuit can be added to enhance the pressure setting range.

### CROSS-REFERENCE TO RELATED APPLICATIONS

This application is a 371 National Stage Application of PCT/EP2007/063379, filed Dec. 6, 2007. This application claims the benefit of U.S. Provisional Application No. 60/875,471, filed Dec. 18, 2006, which is incorporated by reference herein in its entirety. In addition, this application claims the benefit of European Application No. 06125761.4, filed Dec. 11, 2006, which is also incorporated by reference herein in its entirety.

### BACKGROUND OF THE INVENTION

1. Field of the Invention

The present invention relates to a regulated air supply system for an ink supply system in an inkjet printer. More specifically the invention is related to a air supply system mounted on the printing shuttle of a inkjet printer.

2. Description of the Related Art

### Inkjet Printing

Nowadays a lot of printed matter is produced carrying a reproduction of a color image. A large part of these color prints are produced using offset printing but in office and home environment a lot of color prints are made using relatively small printing apparatuses.

One of the possible printers used is an inkjet printer. In an inkjet printer drops of ink are jetted out of nozzles towards a receiving layer which may be, e.g., specially coated paper.

Usually an inkjet print head has an array of nozzles, each nozzle jetting ink to a different location at the same time.

The ink is jetted out of the nozzles by use of, e.g., a thermal or piezoelectric actuators creating a pressure wave.

It is normally the intention that the size of the droplets can be kept constant or that there is a good control of the droplet size in printers capable of recording variable droplet sizes.

### Print Head

An inkjet print head contains capillary tubes having a nozzle end and an inlet end. For each tube an actuator is provided for creating a pressure wave expelling the ink out of the nozzle at the end. At the other end ink is fed to the print head from an ink tank.

In normal rest condition the ink forms a meniscus at the nozzle end in the capillary tubes which is influenced by surface tension forces. An other force acting upon the ink is the “hydrostatic” pressure caused by gravity due to the height of the ink above the meniscus. Because the inkjet print head is fully filled with ink and it is connected to an ink tank normally above the printhead the ink tank, the level of the ink in this header tank determines the pressure of the ink in the print head. When the ink tank is placed above the print head, a positive ink pressure will arise due to the vertical height difference between ink level and nozzles.

The ink pressure at the nozzle and the surface tension forces determine the shape of the meniscus. Some types of print heads need a stable negative ink pressure at the nozzle area for good printing.

To reach finally a negative pressure at the nozzles, this positive pressure can be neutralized by applying a negative pressure above the ink in the header tank.

A problem is that in order to obtain constant or controllable recording quality the negative pressure in the head and tank is to be kept constant or within a small range.

When the pressure in the printhead is to high drooling of ink from the printhead may occur. When the pressure is to low air may be sucked into the printhead which makes nozzles inoperative resulting in image defects.

Shuttling Print Head with Header Tank

Inkjet print heads can be as large as the transversal size of an image or text to be printed but usually the size of the print head is smaller. Page wide print heads are still expensive and less reliable than smaller types.

A whole image is composed in an inkjet printer using a method wherein a receiving sheet, e.g., a sheet of paper is transported in one direction and passes gradually underneath the printing station.

The print head which has a size which is smaller than the receiving sheet shuttles transversal to the transport direction of the sheet over it and consecutively records one or more lines when shutting over the sheet. The image is composed gradually.

It is possible that several print heads are used to record different colors and a color image is recorded by superposition of the different color images.

In order to enable continuous operation of a print head, an ink tank containing an ink supply is coupled to the print head.

Small printers usually have a small cartridge, optionally with integrated print head nozzles, containing only a limited amount of ink. When empty these cartridges have to be replaced.

In recent time inkjet printing technology is also used in large format, high volume printers

High end inkjet printers having a high throughput or large formats however consume a large amount of ink.

The inkjet print head of a high end printer is coupled an ink tank mounted on the shuttling carriage carrying the print head.

This ink tank is called a header tank and can be refilled out of a large capacity ink tank which is stationary.

### Refilling of the Header Tank

Possible refill arrangements can be found in EP-A-1 097 814.

When the level of ink in the header tank is to low the shuttling carriage is transported to a refilling station outside the printing area where the header tank is refilled.

A considerable problem in this method is the difficulty to maintain a constant ink pressure in the print head. The height of the level of ink in the header tank diminishes constantly giving rise to less pressure due to gravity and causing variations in recording quality.

The level can be kept relatively constant by refilling very often but no recording can be done during refilling giving rise to lower throughput rates as the carriage has to be stopped each time.

In EP A 1 142 713 a system for refilling a header tank is described wherein refilling can be done during printing. The header tank on the shuttling carriage is connected by flexible tubes to a feeder tank. The main tank is pressurized and when a replenishing valve is opened ink is pressed by the air pressure from the feeder tank to the header tank during printing operation. A supplementary valve is placed between the header tank and the print head.

### Using Different Inks/Heads

Another possibility is that in industrial printers sometimes different types of inks are used. The print head and/or header tank are usually exchanged but the rest of the printer parts will not be changed.

Some known types of ink are solvent type, water based and radiation curable. Different ink however exhibit different properties such as density and viscosity, surface tension, thermal characteristics which may all influence the forming of drops.

It can be understood that, dependent upon the type of ink, the control means of the pressure in the header tank has to be adaptable to adjust for the different kinds of ink and uses.

It is also possible to use another type of head having other characteristics so that the backpressure needed for good operation has to be set to another value. Even replacement of a defective printhead may lead to adjustment of the backpressure to allow good operation of the new printhead.

### Unblocking Nozzles

In some industrial applications, such as making of printing plates using ink-jet processes, inks having special characteristics causing specific problems. E.g., UV curable inks exist to allow rapid hardening of inks after printing.

The combination of small nozzles and quick drying ink leaves the print heads susceptible to clogging, not only from dried ink and minute dust particles or paper fibers, but also from the solids within the new ink themselves.

It is known to counteract or correct the problem of clogging by protecting and cleaning the print head by various methods.

Some of these methods is vacuum assisted purging: During a special operation in order to clear partially or fully blocked nozzles a printing is actuated while on the outside of the nozzles a vacuum is applied. This helps clearing and cleansing the nozzles. The purging is normally performed when the print head is in the capping unit as this unit can provide a good seal around the nozzle array for building the vacuum. A higher ink pressure inside the printhead and thus also inside the ink tank is desirable.

Another known technique for cleaning a nozzle plate includes that the nozzle plate is wetted by bleeding ink from the nozzles, the term sweating nozzle plate is also sometimes used. To obtain this diminished ink delivery the pressure in the head, and thus in the ink tank has to be set to a specific value. By wetting the nozzle plate dried residues on the plate are dissolved and better results are obtained during subsequent brushing and/or wiping.

In some ink supply systems, such as in the PCT application PCT/EP2005/056816, there is an ink flow through the print head from one (feeding) ink tank to a (receiving) ink tank. In order to remove trapped air inside the printhead the ink flow system is flushed by raising the flow through the printhead whereby trapped are is carried away by the fast flowing are. The flow is generated by creating a pressure difference between the two ink tanks. A pressure difference can easily be created by raising the pressure inside one ink tank.

From the above examples it is clear that there is a need for an easy settable system for creating a variable pressure inside an ink tank.

Hitherto several pressure regulating systems are suggested.

In U.S. Pat. No. 5,646,666 a system is disclosed for regulating the back pressure in a reservoir. As the system is based upon a mechanical actuated valve system, the pressure is not settable and no measurement is done.

U.S. Pat. No. 6,698,869 discloses a controlled vacuum generated by a vacuum pump, a solenoids valve and a accurate pressure sensor. A single controlled vacuum source can be used to control multiple printheads with multiple chambers. Higher pressure is possible by connecting the ink tank to the ambient pressure.

This however does not allow for a low cost system including independent settable variable pressure levels in the different ink tanks.

In U.S. Pat. No. 6,705,711 a system is described using a vacuum source such as a pump with an accumulator or a vacuum pump with air bleed. The vacuum source is said to be settable by a sensor giving signals to a controllable pump. This would need a separate pump system for all the ink reservoirs if one desires that different pressure levels are needed due to, e.g., in characteristics, etc.

Published application US 2005/0146572 discloses a pump for delivering positive pressure to a print head and valves at least two pressure regulating orifices, possibly switched by a valve, each orifice limiting the pressure to a certain value. By this system only a positive pressure can be given and the number of pressure levels which can be set is limited by the number of pressure regulating orifices. No free choice of the pressure level is possible and no measurement system is present.

In U.S. Pat. No. 5,555,005 a pressure regulating system uses an intermediate volume that is filled with air from a pressure source or air at atmospheric pressure and then connected to an ink tank to step-wise rise or lower the pressure in the ink tank.

As can be seen from the above stated problems and known state of the art there is still a need for flexible, electronically settable, easily regulated vacuum/pressure source for each individually ink tank.

### SUMMARY OF THE INVENTION

In order to overcome the problems described above, preferred embodiments of the present invention provide a shuttle air supply system for an inkjet printer having the specific features described below. Specific features for other preferred embodiments of the present invention are also described below.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 shows a basic preferred embodiment of an shuttle air supply system according to the present invention.

FIG. 2 shows a shuttle air supply system having a vacuum and air pressure supply lines.

FIG. 3 shows an air supply system combining two ink tanks having an interconnection line.

FIG. 4 depicts the use of an air supply module for two ink tanks.

FIG. 5 shows the use of several air supply modules on a shuttle.

FIG. 6 shows the use of a buffer volume.

### DETAILED DESCRIPTION OF THE PREFERRED EMBODIMENTS

While the present invention will hereinafter be described in connection with preferred embodiments thereof, it will be understood that it is not intended to limit the invention to those preferred embodiments.

As mentioned above, in most inkjet printing systems the desired ink pressuring the intermediate ink tank or header tank is lower than the ambient pressure to avoid drooling and to obtain good printing quality. For several types of ink the pressure in the ink tank normally tends to rise as air is drawn from the ink due to the lower pressure above the ink level. Because of this “degassing” effect together with the fact that extra ink is pumped ink into the ink tank, the ink tank pressure tends to rise slowly.

A preferred embodiment of the present invention obtains a settable pressure using a shuttle air supply system for regulating air pressure in at least one ink tank on an ink jet shuttle in an inkjet printing system including at least one vacuum supply line for coupling a substantially fixed value vacuum source to at least one ink tank, at least one vacuum valve for controlling the opening of the vacuum supply line, at least one pressure sensor coupled to the ink tank for sensing the pressure in the ink tank and supplying the measurements to a valve control circuit for actuating the vacuum valve, characterized in that the air pressure in the ink tank can be regulated to a desired ink tank pressure by the valve control circuit by switching of the vacuum valve to a connection state thereby connecting the ink tank to the vacuum source thereby lowering the ink tank pressure and wherein the switching is based upon pressure sensor measurements and desired ink tank pressure.

A first and most basic preferred embodiment of the invention is given in FIG. 1.

The shuttle air supply system includes following components: a vacuum supply line 11 which couples a substantially fixed value vacuum source 1 to an ink tank 10, a valve 12 which can control the opening of the vacuum supply line 11, a pressure sensor 13 measures the pressure inside ink tank 10 and the measurements of the pressure sensor 13 are supplied to a valve control circuit 9 which actuates the vacuum valve 12. The actuation of the valve 12 is based upon measured ink tank pressure and the desired ink tank pressure.

Hereinafter the different components and their function are further explained.

A substantially fixed value vacuum source 1 is a vacuum source which is intended to have a fixed vacuum level but as it is impossible to generate such a perfect vacuum source due to design and cost limitations, small pressure variations are present.

Although the way the vacuum is generated is not important for the present invention, some examples of such a substantially fixed value vacuum source 1 will be given.

A vacuum pump can be regulated by a, preferably accurate, sensor setting the speed of the pump.

An even more accurate vacuum level can be generated when the pump is coupled to a buffer volume smoothing out any pressure variations.

A more simple but less technical sophisticated system uses a pump generating a vacuum which is limited using a bleed valve which opens when the fixed vacuum level is attained.

A typical vacuum level of the fixed value vacuum supply is, e.g., about −300 mbar but may vary depending upon the desired pressures that one needs in the ink tank and the speed of which a pressure change is needed.

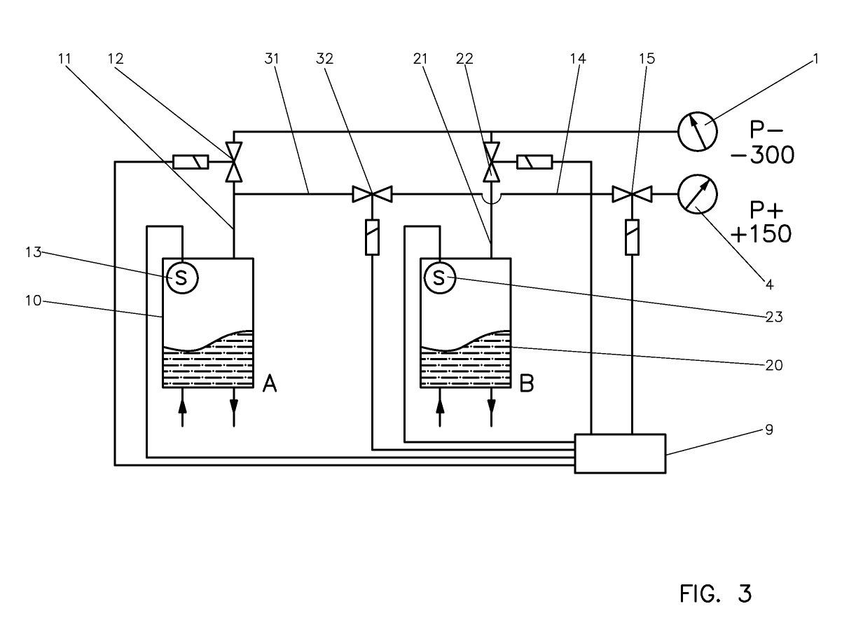

The vacuum supply line 11 has a function to couple the vacuum source 1 to the ink tank 10. This does not mean that this is, e.g., a single tube which connects the tank 10 and the vacuum source 1. It merely means that the vacuum supply line 11 is the pass-way through which the vacuum attains the ink tank 10. A part of the vacuum supply line 11 can be used for another function and can coincide with, e.g., a pressurized air supply line 14 as can be seen in FIG. 3. This will become more clear in the description of the practical preferred embodiments later on.

In FIG. 1 only a single ink tank 10 is shown, but it can be understood that the system can also be used for several ink tanks using several different layouts of the system according to the invention.

Concerning the vacuum valve 12, it is clear that a single valve can be used for a single tank, but one can see that one valve could regulate the pressure in several ink tanks which need to have the same pressure and which are interconnected by a manifold.

A single tank could have parallel connections with the vacuum source wherein each vacuum supply line has his own valve. These valves could have the same opening or each valve can have its own diameter so that the opening between vacuum source and ink tank can be chosen by opening a specific combination of valves.

Other valve systems may include valves having more than two possible states. The valve may be fully closed, fully opened or in between. Even systems wherein the valve openings can be varied continuously can be used.

The valves are commanded by the valve control circuit 9.

The steering of the valves can also happen in different ways.

When the ink tank pressure needs to be lowered, the valve is opened until a desired value is reached. This would lead into a sudden change of pressure inside the tank 10.

Upon detection of a deviating ink tank pressure the valve 12 is actuated intermittently by periodically opening and reclosing the valve thereby lowering the ink tank pressure gradually. By the intermittent valve switching the opening of the vacuum supply line 11 is time modulated by the valve 12. The time modulation of the valve 12 could have different regimes. The period for which the valve 12 is opened can be changed, e.g., upon the difference between detected and desired pressure values. Also the period in between the successively openings of the valve 12 can be changed dependent upon the pressure measured or upon parameters given by the general print controller.

When using valves capable of more than two states of which the opening can be changed continuously, even more different systems can be used to control the opening of the vacuum supply line 11. The opening can be modulated in time (how long an opening is made) and in amplitude (the size of the opening the valve 12). Time and opening value of the valve can be set based upon measured ink tank pressure, desired pressure and even further parameters given by the printer system to the valve control circuit 9, e.g., ink level in the tank 10.

The pressure sensor 13 can be mounted inside the tank 10, or can be positioned at the side of the tank 10 in connection with the interior.

It is even possible to locate the pressure sensor 13 at a relatively large distance from the tank 10 itself, the sensor 13 only needs to be coupled to the tank 10 by, e.g., a small tube or pipe.

The only restriction is that the connection between the tank 10 and the sensor 13 allows for detection of change of pressure at a speed that is desired for the control process. A tube too long and narrow would lead to a long pressure leveling time so that the pressure level would be difficult to control and can even lead to resonant conditions in the control procedure.

Several types of pressure sensors 13 can be used and are known to a person skilled in the art. The output of the these sensors can be very simple, e.g., just indicating that the pressure level is above or below a certain value, but this would not allow for settable ink tank pressures and adaptive control mechanisms. Preferably more sophisticated analog or digital values can be the output given to the valve control circuit to allow for the use of settable ink tank pressure dependent upon working conditions and/or types of ink etc.

### Operation of the System

During operation the ink tank pressure is detected by the pressure sensor 13 and the measurement is send to the valve control circuit 9. The measured value is compared to the desired value given by, e.g., the main printer controller and when it is detected that the ink tank pressure is to high the vacuum valve 12 is actuated to lower the ink tank pressure by connecting the substantially fixed value vacuum source 1 to the ink tank 10. The valve 12 can be actuated a predetermined period, possible based upon the measurement or can be left open till the pressure inside the tank 10 lowers until it reaches a desired pressure level.

The above described preferred embodiment however has still some drawbacks. Only negative pressures are obtainable. And, if the (negative) pressure is too low, e.g., by a large sudden outflow of ink, the pressure cannot be raised to reach the desired operating pressure. It is advantageous that a larger regulating range can be spanned.

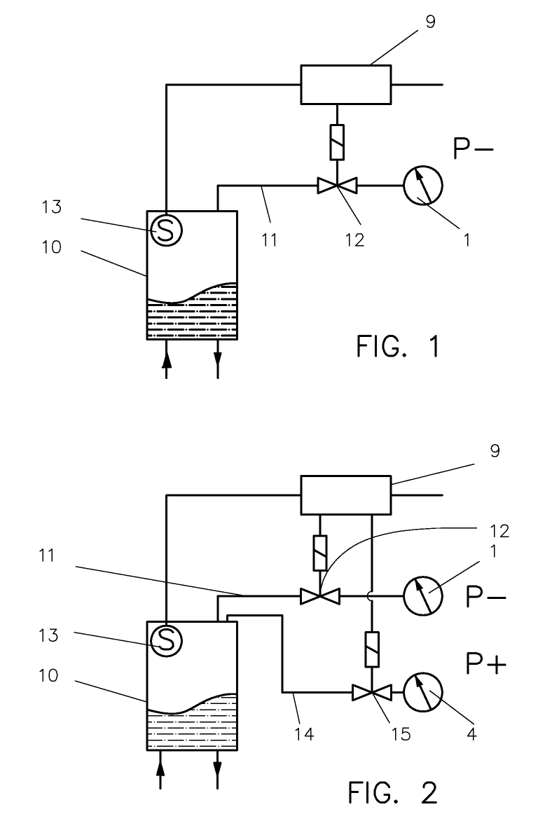

The preferred embodiment of FIG. 2 solves the further problem by adding a pressurized air supply line 14 for connecting a substantially fixed value pressurized air supply 4 the to the ink tank 10, and at least one air pressure valve 15 controlling the opening of the pressurized air supply line 14 controlled by the valve control circuit 9.

A substantially fixed pressurized air supply 4 can be a compressor combined with a controller steering the compressor or using a pressure regulator using a membrane.

Likewise the vacuum supply line 11, parts of the air pressure supply line 14 can coincide with tubes having another function such as the vacuum supply line 11.

A typical positive pressure source can be about +150 mbar and should be at least above the maximum pressure that is needed inside the ink tank 10.

The used valve 15 can have the same possibilities as the vacuum valves 12 above but other dimensions may be needed to obtain ideal working conditions of the control process.

The air pressure valve 15 is also actuated by the valve control circuit 9 and the pressure inside the tank 10 can thus be lowered or raised by opening of the vacuum valve 12 or air pressure valve 15.

Simultaneously switching of the valves 12,15 would also be possible to obtain other characteristics in the lowering or raising curve of the ink tank pressure.

The pressure in the ink tank during printing is typical in the order of −40 to −90 mbar, although dependent upon the configuration and the ink other pressure can be used.

When the pressure sensor 13 is very accurate, it is possible to obtain a controllable pressure over a large range. This can be practical when using very different types of ink (weight, viscosity, adhesion) or when want pressure to be raised for the purpose of purging the printhead or for wetting the nozzle plate of the printhead by bleeding of ink from the nozzles by raising the pressure to a level wherein the meniscus breaks.

A further described preferred embodiment can be found in FIG. 3.

This is a practical preferred embodiment for using with a throughflow printhead 60 which is connected to two ink tanks 10,20.

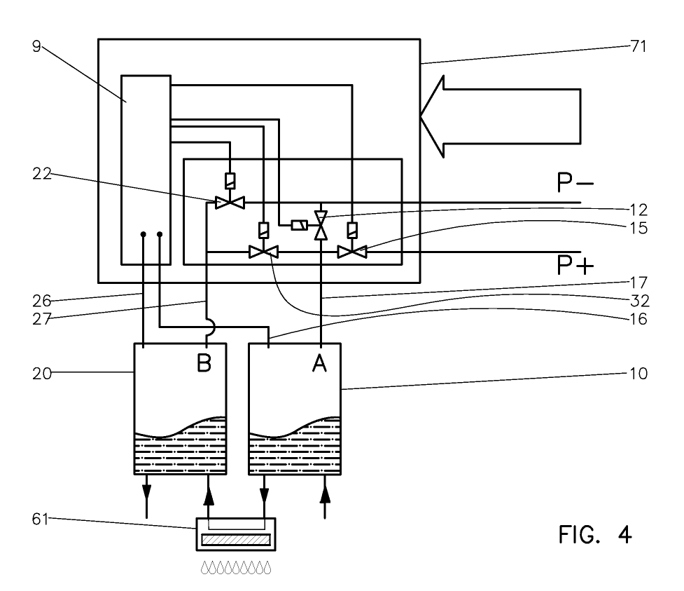

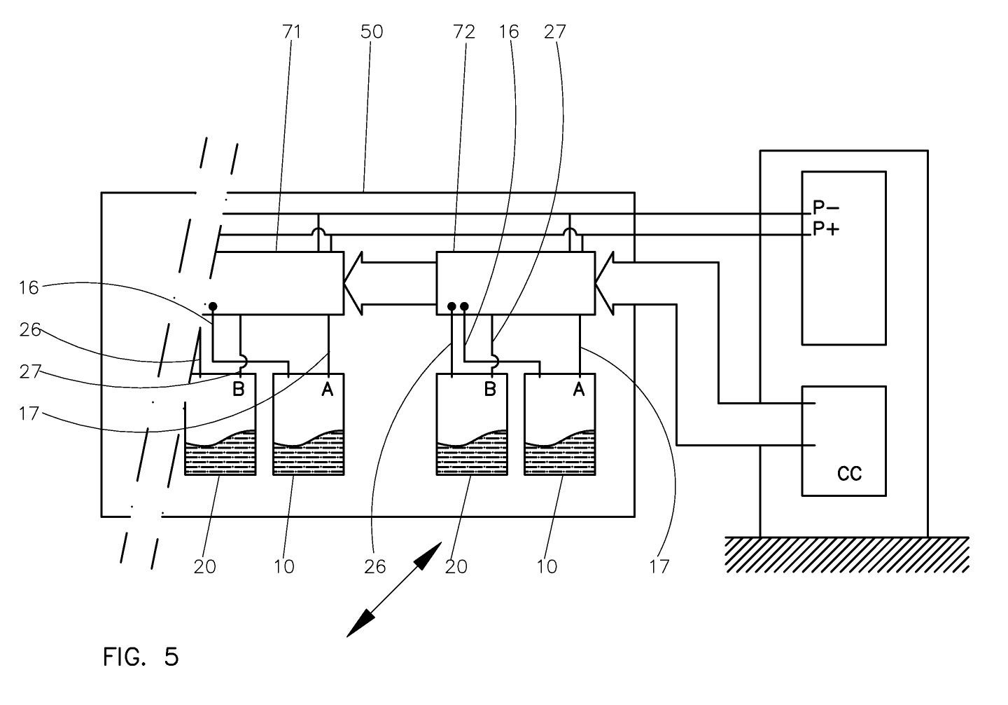

As also shown in FIG. 4, the first ink tank 10 acts as a supply to the inkjet printhead 61 while the second ink tank 20 serves as a drain for the ink leaving the printhead 61. The first ink tank 10 normally receives preferably reconditioned unused ink or fresh ink from a main ink supply, depending upon the printer system.

The ink in the second ink tank 20 usually is pumped away for reconditioning and/or reuse in the printer.

Each ink tank 10,20 is coupled to a pressure sensor 13,23 and both pressure sensors 13,23 send their measurements to the valve control circuit 9 which controls several valves 12,32,15,22 and thus determines the pressures inside the ink tanks 10,20.

In order to obtain the desired ink flow through the printhead 61, the pressure inside the first ink tank 10 can be set higher than the pressure in the second ink tank 20.

While the flow through the printhead 61 is determined by the difference between the pressures in the first and second ink tanks 10,20, it are the absolute pressure levels inside the tanks which determine the working pressure in the inkjet printhead 61.

In the preferred embodiment of FIG. 3 each ink tank 10,20 has his own vacuum supply line 11,21 while it is the feeding tank 10 which has a air pressure supply line 14.

By setting the pressures in both tanks 10,20 a good working pressure inside the inkjet printhead 61 can be generated at a desired through flow determined by the pressure difference. Printing can also be done without a throughflow in the printhead.

By setting the first tank 10 to a positive pressure and the second tank 20 to a negative pressure the inside of the printhead 61 can be flushed to remove particles or air bubbles which may have settled inside the printhead 61.

By using the interconnection line 31 to bring the pressures in both tanks 10,20 at the same level throughflow can be stopped.

Another function of the interconnection line 31 is during purging. Both ink tanks 10,20 are interconnected and a positive pressure is applied through the pressure supply line 14. This way ink is purged out of the nozzles which may be needed to free blocked nozzles.

It is also possible to provide each ink tank 10,20 with both a vacuum and pressure supply line so that the pressure in each tank 10,20 can be set independently. When using this designs, it is however more difficult to ensure that the pressure in both tanks 10,20 is the same. This can be easier obtained by using an interconnection line 31.

As mentioned above the vacuum supply line also may have other functions. This can be seen in FIG. 3. wherein a major part of the vacuum supply line 11 is also a part of the pressure supply line and the interconnection line.

In reality following typical pressures can be used in a dual tank system:

During printing: −40 to −90 mbar in both tanks 10,20
During purging: about +150 mbar in both tanks 10,20
During flushing of the printhead: about +150 mbar in the supply tank 10 and about −50 to −100 mbar in the drain tank 20

It is emphasized that the opening and closing of the valves 12,32,15,22 can be constantly evaluated using the readings of the pressure sensors 13,23 and the desired pressure levels given from the main controller.

Thus, e.g., purging could be done at several different pressures by modulating the opening of the air pressure supply line 14, generating the desired positive pressure while the interconnection line 31 is left open.

FIG. 4 gives a idea of a practical design of the preferred embodiment of FIG. 3.

The pressure sensors 13,23, valves 12,32,15,22 and electronics of the valve control unit 9 are located inside a module 71. The ink tanks 10,20 are only connected to the modules by small tubes, one sensor connection tube 16,26 for connection to the pressure sensors 13,23, e.g., mounted on the electronic board of the module 51 and an ink tank connection tube 17,27 for supply of vacuum and/or air pressure to the tank 10,20.

The module 71 is fed by: a line to the substantially fixed vacuum source 1, a line to the substantially fixed value pressurized air supply 4, and an electronic connection to the main print controller for setting the desired printing pressures.

Such a module 71 is easily replaceable and does not need extensive tubing and wiring around the ink tanks 10,20.

FIG. 5 gives a possible construction for a printer having several printheads, not shown mounted on a shuttle 50.

The vacuum source 1 and air pressure source 4 are mounted off-shuttle and the vacuum and air pressure are distributed to the different modules 71,72 units by splitting of the lines on the shuttle itself.

The modules 71,72 are all connected to the main controller using a data bus system to set the pressures by the main print controller.

A shuttle air supply system module 71,72 can be used for each two tanks 10,20 coupled to a printhead, not shown, but it is also possible that several printheads, preferably using the same ink, are coupled to one module, thereby reducing the number of needed modules.

As no ink is in contact with the air supply modules, it is even possible to use the same module for ink tanks having different colors of ink in them. However when plural ink tanks system are coupled to one air supply module they can not be flushed or purged separately unless extra valves are provided for separating certain ink flow circuits.

The use of the shuttle air supply modules is especially advantageous in industrial inkjet printing machines wherein for a lot of different ink tanks a different pressure need to be set in a easy and flexible way.

A single vacuum and air pressure source can be used instead needing separate settable vacuum sources. No manually controlled bleed valves or membrane pressure control devices need to be adjusted when a different pressure is needed.

An even more accurate pressure setting system can be obtained by a modification. The pressure change in a system and the speed at which the change is made upon opening of an air pressure or vacuum valve depends on several parameters:

The length of time during which the valve is opened.

The size of the opening of the valve or pressure of vacuum supply line and the length of the supply line.

The pressure difference of the pressure or vacuum source to the pressure of the ink tank.

The volume of the air in the ink tank.

For a more stable control of the pressure inside the ink tank 10, the following preferred embodiment can be used. An accurate and more slowly changing pressure inside the ink tank 10 can be obtained by enlarging the volume of air above the ink in the ink tank 10 so that the air in the ink tank has a certain buffer capacity to counteract sudden pressure changes.

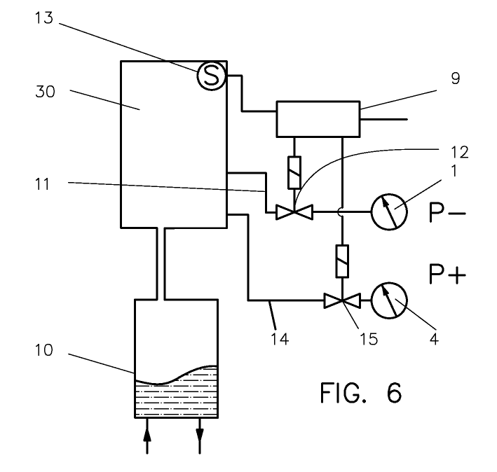

As shown in FIG. 6, this is done by coupling a large buffer tank 30 to the ink tank 10; the pressure sensor 13 is coupled to the buffer tank 30.

This is advantageous when a sudden ink consumption occurs. Such an event would cause a quick pressure change in a small ink tank but will cause a smaller change in a large ink tank.

In a small ink tank the use of an accurate pressure sensor 13 would not result in a better pressure regulation as the opening of the pressure or a vacuum valve would probably cause an overshoot of the ink tank pressure relative to the desired pressure.

As shown in FIG. 6, it is preferred that the expansion of the buffer volume of air in the ink tank is done using an buffer volume 30 coupled to the ink tank 10 by a extra tube.

This way the volume of the ink tank 10 which is often smaller than 100 ml can be increased by coupling a buffer tank 30 of, e.g., 2 liters to the ink tank. The buffer tank 30 does not contain any ink and stores only air. This has the result that the air pressure is much more stable as pressure variations as a reaction of opening a valve would occur much slower and much more smoothly than using only a small tank.

It has been found that it is possible to reduce the pressure variations in the system to less than 1 mbar. This is especially important as the typical negative pressure in the system at the printhead is about 2 mbar, preferably without any pressure variation.

Pressure sensor 13, the vacuum supply line 11 and the pressurized air supply line 14 can be coupled to the buffer tank 30 as shown in FIG. 6.

One buffer tank can be connected to plural ink tanks to enlarge the regulated volume as long as these tanks need to have the same pressure.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10. A shuttle air supply system for an ink jet shuttle in an inkjet printing system, the shuttle air supply system comprising:
an ink tank;
a vacuum supply line arranged to couple a substantially fixed value vacuum source to the ink tank;
a vacuum valve in the vacuum supply line arranged to open and close the vacuum supply line;
a valve control circuit arranged to actuate the vacuum valve; and
a pressure sensor coupled to the ink tank and arranged to measure a pressure in the ink tank and to supply pressure measurements to the valve control circuit to actuate the vacuum valve; wherein
the pressure in the ink tank is regulated to a desired ink tank pressure by the valve control circuit switching the vacuum valve to a connection state in which the ink tank is connected to the vacuum source to lower the ink tank pressure; and
the valve control circuit is arranged to perform the switching of the vacuum valve based upon the pressure measurements and the desired ink tank pressure.

11. The system according to claim 10, further comprising:
a pressurized air supply line arranged to connect a substantially fixed value pressurized air supply to the ink tank; and
an air pressure valve in the pressurized air supply line arranged to open and close the pressurized air supply line, the air pressure valve controlled by the valve control circuit; wherein
the air pressure in the ink tank is regulated to the desired ink tank pressure by the valve control circuit switching the vacuum valve and the air pressure valve based upon the pressure measurements and the desired ink tank pressure thereby lowering or raising the ink tank pressure.

12. The system according to claim 10, further comprising:
a second ink tank;
a second vacuum supply line arranged to couple the substantially fixed value vacuum source to the second ink tank;
a second vacuum valve in the second vacuum supply line arranged to open and close the second vacuum supply line; and
a second pressure sensor coupled to the second ink tank and arranged to measure a pressure in the second ink tank and to supply second pressure measurements to the valve control circuit; wherein
the pressure in the ink tank and the second ink tank is regulated to the desired ink tank pressure by the valve control circuit switching the vacuum valve and the second vacuum valve to the connection state and a second connection state in which the second ink tank is connected to the vacuum source; and
the valve control circuit is arranged to perform the switching based upon the pressure and the second pressure measurements and the desired ink tank pressures.

13. The system according to claim 11, further comprising:
a second ink tank;
a second vacuum supply line arranged to couple the substantially fixed value vacuum source to the second ink tank;
a second vacuum valve in the second vacuum supply line arranged to open and close the second vacuum supply line;
a second pressure sensor coupled to the second ink tank and arranged to measure a pressure in the second ink tank and to supply second pressure measurements to the valve control circuit; wherein
the pressure in the ink tank and the second ink tank is regulated to the desired ink tank pressure by the valve control circuit switching the vacuum valve and the second vacuum valve to the connection state and a second connection state in which the second ink tank is connected to the vacuum source; and
the valve control circuit is arranged to perform the switching based upon the pressure and the second pressure measurements and the desired ink tank pressures.

14. The system according to claim 12, further comprising
an interconnection line arranged to connect the ink tank and the second ink tank; and
an interconnecting valve in the interconnection line arranged to open and close the interconnection line; wherein
the interconnecting valve is controlled by the valve control circuit.

15. The system according to claim 13, further comprising
an interconnection line arranged to connect the ink tank and the second ink tank; and
an interconnecting valve in the interconnection line arranged to open and close the interconnection line; wherein
the interconnecting valve is controlled by the valve control circuit.

16. The system according to claim 10, wherein the substantially fixed value vacuum source is not mounted on the ink jet shuttle, and the vacuum valve, the pressure sensor, and the valve control circuit are mounted on the ink jet shuttle.

17. The system according to claim 11, wherein the substantially fixed value vacuum source is not mounted on the ink jet shuttle, and the vacuum valve, the pressure sensor, and the valve control circuit are mounted on the ink jet shuttle.

18. The system according to claim 12, wherein the substantially fixed value vacuum source is not mounted on the ink jet shuttle, and the vacuum valve, the second vacuum valve, the pressure sensor, the second pressure sensor, and the valve control circuit are mounted on the ink jet shuttle.

19. The system according to claim 13, wherein the substantially fixed value vacuum source is not mounted on the ink jet shuttle, and the vacuum valve, the second vacuum valve, the pressure sensor, the second pressure sensor, and the valve control circuit are mounted on the ink jet shuttle.

20. The system according to claim 16, wherein the vacuum valve, the pressure sensor, and the valve control circuit are located in a unitary air supply module which is connected to the ink tank by an ink tank connection tube and a sensor connection tube, and the unitary air supply module is connected to the substantially fixed value vacuum source.

21. The system according to claim 17, wherein the vacuum valve, the pressure sensor, and the valve control circuit are located in a unitary air supply module which is connected to the ink tank by an ink tank connection tube and a sensor connection tube, and the unitary air supply module is connected to the substantially fixed value vacuum source and to the substantially fixed value pressurized air supply.

22. The system according to claim 18, wherein the vacuum valve, the second vacuum valve, the pressure sensor, the second pressure sensor and the valve control circuit are located in a unitary air supply module which is connected to each of the ink tank and the second ink tank by an ink tank connection tube and a sensor connection tube, and the unitary air supply module is connected to the substantially fixed value vacuum source and to the substantially fixed value pressurized air supply.

23. The system according to claim 19, wherein the vacuum valve, the second vacuum valve, the pressure sensor, the second pressure sensor and the valve control circuit are located in a unitary air supply module which is connected to each of the ink tank and the second ink tank by an ink tank connection tube and a sensor connection tube, and the unitary air supply module is connected to the substantially fixed value vacuum source and to the substantially fixed value pressurized air supply.

24. The system according to claim 10, further comprising a buffer tank coupled to the ink tank and arranged to increase a regulated volume of the ink tank.

25. The system according to claim 24, wherein the pressure sensor and the vacuum supply line are coupled to the ink tank via the buffer tank.

26. The system according to claim 10, wherein the valve control circuit is arranged to regulate the desired ink tank pressure by intermittent valve switching performed by the valve control circuit.

27. The system according to claim 11, wherein the valve control circuit is arranged to regulate the desired ink tank pressure by intermittent valve switching performed by the valve control circuit.

28. The system according to claim 12, wherein the valve control circuit is arranged to regulate the desired ink tank pressure by intermittent valve switching performed by the valve control circuit.

29. The system according to claim 13, wherein the valve control circuit is arranged to regulate the desired ink tank pressure by intermittent valve switching preformed by the valve control circuit.
